(19) United States
(12) Patent Application Publication
(10) Pub. No.: US 2010/0054951 A1
(43) Pub. Date: Mar. 4, 2010

(54) Dual Zone Amplifier Turbine Blade

(76) Inventor: Edward Frederick Loutensock, Sutter Creek, CA (US)

Correspondence Address: Edward Frederick Loutensock, 37 South Main Street #201, Sutter Creek, CA, 95685, US

(21) Appl. No.: 12/231,667

(22) Filed: Sep. 3, 2008

(51) Int. Cl. F03D 1/06; F01D 5/14

(52) U.S. Cl. 416/243

(57) ABSTRACT

The Dual Zone Amplifier Turbine Blade is for use on a vertical axis wind turbine. It is a 40 degree conic with a three sided opening at the base region for wind collection. The 40 degree conic turbine blade allows for amplification of collected wind and minimum air resistance to foreword movement. The curved, three sided opening at the base region allows for maximum collection of wind. When attached to a spoked hub in balanced plurality for the purpose of turning an electric generator or other device, an efficient collection, amplification and transfer of wind energy is attained.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A SEQUENCE LISTING, A TABLE, OR A COMPUTER PROGRAM LISTING COMPACT DISC APPENDIX

Not Applicable

### BACKGROUND OF THE INVENTION

The Dual Zone Amplifier Turbine Blade pertains to the field of green energy production as a vertical axis wind turbine blade. It's ability to collect, amplify and transfer energy from the wind or air movement to produce mechanical motion, combine for improved efficiency. The improvements to the current state of the art is an amplification of wind energy gathered and reduced wind resistance to foreward movement.

### BRIEF SUMMARY OF THE INVENTION

Conical, with a 40 degree profile, it is orientated horizontally, so that the perpendicular to the base of a complete cone is parallel to the ground. There are two zones of the Amplifier turbine blade. A curved, three sided collection zone that captures the available wind energy and an amplification zone, the inside of the leading portion of the blade. The problem of efficient wind collection is solved with a wide entrance into the turbine blade. Amplification and reduced air resistance are both achieved by the closed leading portion of the conic shape, amplification inside and reduced air resistance outside.

### BRIEF DESCRIPTION OF THE SEVERAL VIEWS OF THE DRAWING

FIG. 1 Side View, Inside Arc

FIG. 2 Top View

FIG. 3 Side View, Outside Arc

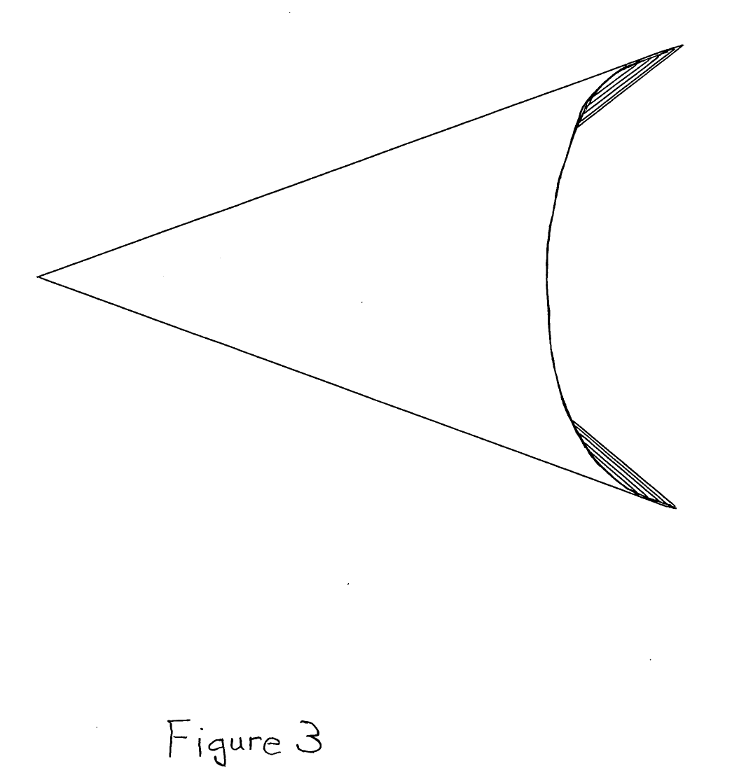

### DETAILED DESCRIPTION OF THE INVENTION

The Dual Zone Amplifier Turbine Blade is a type of vertical axis wind turbine blade. A device that converts natural air movement, or wind energy to mechanical motion. Attached to a spoked hub in balanced plurality, so that they travel around a vertical axis parallel to the ground, for the purpose of turning an electric generator, pump or other device.

The collection of wind energy happens when wind enters the three sided opening at the base region of this conic turbine blade. The shape of the opening of the collection zone allows for positive wind collection and effect for 180 degrees of the circular path of the turbine blade. Amplification of wind energy begins upon entry into the collection zone, as the turbine blade is conical in its entirety.

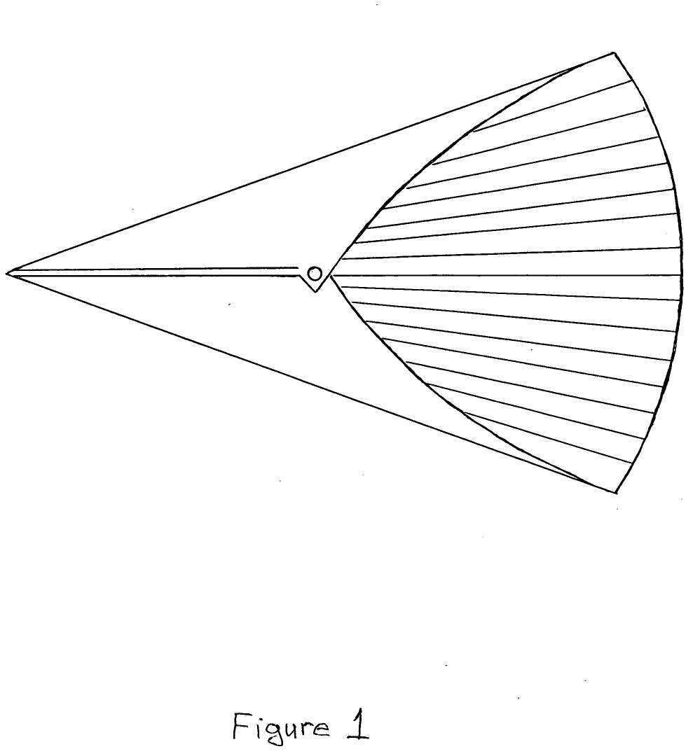

Amplification continues when the collected wind energy enters the inside of the cone, a confined space, ever decreasing to a single point. As the space inside the turbine blade decreases, the force of the collected wind is concentrated, resulting in amplification of wind energy. Amplification of wind energy is passive, as the only stimuli to the wind energy collected is the ever confining space inside the conic. (See FIG. 1)

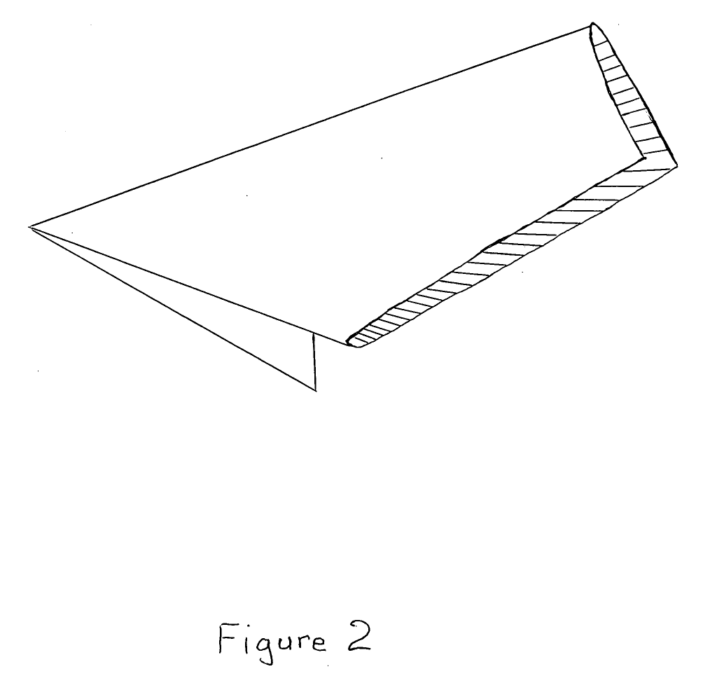

The outside of the turbine blade is led by the point of the 40 degree conic, minimizing air resistance of foreword movement. A fin on the inside arc of the blade, that begins with and at the leading point, increasing in width as it extends parallel to the ground to the point where the collection and amplification zones meet, will stabilize the blade's path through the air and transfer the amplified energy to the spoke. At the intersection of the fin, collection and amplification zones is where the blade attaches to the spoke with simple hardware. (See FIGS. 2 & 3)

Fabrication of the Amplifier Turbine Blade begins with a square sheet of bendable material, such as sheet metal. Designate one side of the square as the reference side and locate the center point of that side. This defines the leading point of the turbine blade and the beginning of the stabilizing fin. Radiating from the center point just defined, scribe two sets of lines at 25.5 and at 35.5 degrees, rising to each adjacent side. Trim material below each 25.5 degree line, leaving a single point remaining of the original reference line. This establishes the edge of the stabilizing fin. At the adjacent side end of each 25.5 degree line, scribe and cut a line toward the 35.5 degree line at an angle of 55 degrees from the adjacent side, forming two triangles of 60, 110 and 10 degrees. This is the two components of the stabilizing fin. Bend both triangles down to 90 degrees of the plane, leaving two triangular tabs on the plane of material. Roll the plane of material up so that the two components of the stabilizing fin meet aligned and flush, forming one complete stabilizing fin, overlapping the triangular tabs. Spot welds, rivets or nuts and bolts on the fin and overlapped triangular tabs hold the shape together.

The Dual Zone Amplifier Turbine Blade's uniqueness in the seamless, dual zone concept. A curved three sided wind collection opening to a 40 degree conic that produces amplification of wind energy and a stabilizing fin of 10 degrees. The blades may vary in size for varied uses, so long as like sizes are attached to the same hub and spoke assembly. A residential application will be smaller than one for industrial use, therefore the scale of the Dual Zone Amplifier Turbine Blade is variable.

1. The claim of the Dual Zone Amplifier Turbine Blade is it's ability to amplify the force of wind energy with a passive, conical, dual zone design.
